(19) United States
(12) Patent Application Publication
(10) Pub. No.: US 2026/0210865 A1
(43) Pub. Date: Jul. 23, 2026

(54) Device for analysis by optical emission spectrometry on laser-produced plasma comprising means for protecting a gas jet

(71) Applicant: FARIAUT INSTRUMENTS, ORLEANS (FR)

(72) Inventor: François FARIAUT, Saint Jean de la Ruelle (FR)

(21) Appl. No.: 19/140,097

(22) PCT Filed: Dec. 18, 2023
(86) PCT No.: PCT/EP2023/086491

§ 371 Date: Jun. 17, 2025

(30) Foreign Application Priority Data
Dec. 20, 2022 (FR) FR2213972

(51) Int. Cl. G01N 21/71

(52) U.S. Cl. CPC G01N 21/718; G01N 2201/08

(57) ABSTRACT

A device for elemental analysis of a sample to be studied. The device includes: a base intended to support a sample to be studied; a system for generating a laser beam intended to impact the sample to generate a plasma generating an optical emission; a collector for collecting the optical emission; and a gas projector for projecting a gas jet onto the sample to be studied.

### CROSS-REFERENCE TO RELATED APPLICATIONS

This Application is a Section 371 National Stage Application of International Application No. PCT/EP2023/086491, filed Dec. 18, 2023, and published as WO 2024/133164 A1 on Jun. 27, 2024, not in English, which claims priority to and the benefit of French Patent Application No. 2213972, filed Dec. 20, 2022, the contents of which are incorporated herein by reference in their entireties.

### FIELD OF THE DISCLOSURE

The present invention relates to the field of high-resolution mapping and analysis of elements in solids.

More particularly, the invention relates, in particular but not exclusively, to a high-resolution analysis device for mapping elements in metallic solids.

The invention can in particular apply to the elemental analysis of hydrogen and oxygen by optical emission spectrometry on laser-produced plasma, in the field of the nuclear industry, or in the aviation or space industry.

### BACKGROUND OF THE DISCLOSURE

In applications such as the characterization of devices subjected to radioactive sources, or the characterization of the aging ability of devices used in particularly harsh environments, for example in aircrafts or spacecrafts, elemental analysis of metal samples could prove to be essential.

More specifically, it may prove necessary to be able to map these elements within the analyzed sample. Mapping means an identification of the elements making up the sample analyzed and, optionally, the distribution and the bond between the various elements.

Such an analysis could prove particularly useful in studies of metal embrittlement by hydrogen, or in studies of aging of fuel cladding in the presence of oxygen, or in studies of embrittlement of fuel cladding caused by the formation of hydrides, these promoting the propagation of cracks.

There are various known methods of mapping elements present in samples.

One of these methods is elemental analysis by optical emission spectrometry on laser-produced plasma, a technique practiced in a natural atmosphere, also referred to by the English acronym “LIBS” corresponding to the English expression “laser induced breakdown spectroscopy”.

This method applies in particular to the in situ inspection and characterization of samples of parts to be analyzed.

A method and a device for elemental analysis by optical emission spectrometry on laser-produced plasma in the presence of argon is described by the patent document published under number EP 0,654,663.

Conventionally, an analysis device comprises a frame on which are mounted:
a base intended to support a sample to be studied;
a module for generating a laser beam intended to impact the sample to be studied in a direction perpendicular to the base, to generate a plasma generating an optical emission;
means for collecting the optical emission;
means for projecting a gas jet onto the sample to be studied, comprising a needle for projecting the gas jet.

The laser beam generated by the generating module, after shaping by the shaping module, is applied to a sample to be studied via the optical focusing means, comprising a focusing lens the axis of which is perpendicular to the surface and located opposite the plasma.

A plasma is then created at the impact of the laser beam on the sample to be studied, the plasma generating an optical emission to be analyzed to map the elements making up the sample studied.

The collection of the optical emission of the plasma is performed by the collection means.

For this purpose, the collection means comprise an optical fiber whose free end is approached as close as possible to the plasma.

Once collected, the optical emission is analyzed by determination means to which the optical fiber is connected.

The means for projecting a gas (Argon or Helium) enable plasma sheathing, i.e. they bring the properties of the gas to the laser-plasma interaction.

They also limit fouling of the focusing lens of the optical means for focusing the laser beam can, by dust produced by the plasma.

However, it was found that the gas jet, although limiting fouling on the focusing lens, produces fouling of the end of the optical fiber intended to capture the optical emission of the light radiation from the plasma.

Consequently, either regular cleaning of the optical fiber must be carried out, or this optical fiber must be kept away from the plasma, and from the dust produced by the plasma, to limit its fouling, this distance nevertheless involving a degradation of the quality of the optical emission capture.

Moreover, according to a conventional implementation of the device described above, the means for projecting a gas are configured to project a gas jet with a flow rate greater than 5 L·min⁻¹, and the needle has an internal diameter of the order of 2 mm.

This configuration involves particularly expensive gas consumption.

### SUMMARY

In particular, an objective of the invention is to overcome the drawbacks of the prior art.

More specifically, the invention aims to provide a device for elementary analysis of a sample to be studied, of the type described previously, which limits, or even eliminates, the drawbacks caused by the projection of a gas jet onto the plasma.

The invention also aims to limit, or even eliminate, fouling of the optical fiber by dust coming from the plasma.

The invention also aims to provide such an analysis device which has reduced gas consumption.

This objective, as well as others that will appear later, is achieved thanks to the invention which has as its object a device for elemental analysis of a sample to be studied, the device comprising:
a base intended to support a sample to be studied;
a system for generating a laser beam intended to impact the sample to generate a plasma generating an optical emission, the generating system being configured to focus the laser beam in a focusing zone;
means for collecting the optical emission, comprising an optical fiber with a free end extending along a first optical axis oriented towards the focusing zone, the optical emission being intended to be collected via the free end;
means for projecting a gas jet onto the sample to be studied, comprising a needle for projecting the gas jet having an end portion extending along a projection axis oriented towards the focusing zone;
   characterized in that, according to an orthogonal projection onto a plane, so-called the base plane, in which the base is inscribed, the portion of the projection axis located on the side of the projection needle with respect to the focusing zone forms an angle less than or equal to 90° with the portion of the first optical axis located on the side of the optical fiber with respect to the focusing zone,
   and in that the device comprises means for moving the sample configured to move the focusing zone on the surface of the sample, according to a movement vector Sd forming an angle less than or equal to 90° with respect to a projection vector Sp of the gas jet along the projection axis, according to an orthogonal projection on a plane in which the surface of the sample is inscribed.

Thanks to the design of the device according to the invention, the means for projecting a gas jet make it possible to limit, or even eliminate, fouling of the optical fiber in addition to limiting fouling of the focusing means.

This is because the relative positioning of the projection needle, relative to the optical fiber and its free end, allows the gas jet to expel the dust from the plasma in a direction opposite to that of the free end of the optical fiber relative to the plasma.

This configuration thus makes it possible to benefit from the advantages of the gas jet, such as the sheathing of the plasma, while limiting the fouling of the focusing means and the free end of the optical fiber.

Advantageously, according to an orthogonal projection on the base plane in which the base is inscribed, the part of the projection axis located on the side of the projection needle with respect to the focusing zone forms an angle between 30° and 90° with the part of the first optical axis located on the side of the optical fiber with respect to the focusing zone.

The advantages provided by the invention are then more pronounced.

According to a preferred design, according to an orthogonal projection on the base plane in which the base is inscribed, the part of the projection axis located on the side of the projection needle with respect to the focusing zone forms an angle of 45° with the part of the first optical axis located on the side of the optical fiber with respect to the focusing zone.

Thanks to this preferred embodiment, the advantages relating to the angle formed by the projection axis with the first optical axis are optimized, and the drawbacks are minimized.

According to a preferred feature, on a plane, called an inclination plane, in which the projection axis is inscribed, and where the inclination plane is orthogonal to the base plane, the projection axis forms an acute angle less than or equal to 30° with respect to the base plane.

In this way, the inclination of the projection needle contributes to improving the advantages of the invention.

According to a preferred solution, according to an orthogonal projection on the base plane, an opening end of the projection needle is positioned at a distance from the focusing zone that is greater than that of the free end of the optical fiber relative to the focusing zone.

The gas jet thus allows the plasma to be enclosed to improve the sheathing and better expel dust that could be directed towards the end of the optical fiber.

According to an advantageous embodiment, the means for projecting a gas jet are configured to project the gas jet at a flow rate lower than 1 L·min⁻¹, preferably with a flow rate of 0.5 L·min⁻¹, and in that the projection needle has at its end portion an inner diameter of less than 1 mm, preferably equal to 0.5 mm.

In this way, a gas saving is achieved compared with the techniques according to the prior art.

In addition, it was found that this configuration allows better targeting of the gas projection on the plasma due to the higher velocity of the gas jet. This results in better ejection of dust coming from the plasma, and a reduction in the fouling of the optical fiber and of the focusing means.

This also brings the end of the optical fiber closer to the plasma, which improves the quality of the analysis.

The invention also relates to a method for elementary analysis of a sample to be studied, comprising:
simultaneously a step of projecting a gas jet onto the sample to be studied, and a step of focusing a laser beam, in a focusing zone, onto said sample to be studied so as to produce a plasma on the surface of this sample, the gas jet being projected along a projection axis oriented towards the focusing zone, the optical emission being intended to be collected via the free end;
a step of analyzing a spectrum of the optical emission emitted by the plasma using an optical fiber with a free end extending along a first optical axis oriented towards the focusing zone;
a step of determining, from this analysis of the spectrum, the elemental composition of the sample;
   characterized in that, during the step of projecting a gas jet, and according to an orthogonal projection onto a plane in which the surface of the sample is inscribed, the portion of the projection axis located on the side of the projection needle with respect to the focusing zone forms an angle less than or equal to 90° with the portion of the first optical axis located on the side of the optical fiber with respect to the focusing zone,
   and in that it comprises a step of modifying the position of the sample to be studied according to a movement vector forming an angle less than or equal to 90°, preferably 0°, with respect to a projection vector of the gas jet along the projection axis, according to an orthogonal projection onto a plane in which the surface of the sample is inscribed.

This method makes it possible to produce the same advantageous effects as the aforementioned device.

The step of modifying the position of the sample is performed after a first focusing of the laser beam and a first projection of a gas jet, or as the focusing of the laser beam and the projection of the gas jet progress.

This step enables the analysis of the sample surface to take place on a part of this surface that is not subject to dust accumulation following the projection of dust by the gas jet.

Advantageously, during the step of projecting a gas jet, the gas jet is projected at a flow rate lower than 1 L·min⁻¹, preferably with a flow rate of 0.5 L·min⁻¹, and at a speed higher than 21 m·s⁻¹, preferably equal to 42 m·s⁻¹.

Gas savings are then achieved while improving the protection conferred on the optical fiber and the focusing means against a risk of fouling, while allowing the optical fiber to be brought closer to the plasma generated to improve the quality of the analysis performed.

### BRIEF DESCRIPTION OF THE DRAWINGS

Other features and advantages of the invention will become apparent upon reading the following description of different preferred embodiments of the invention, given as illustrative and non-limited examples, and from the appended drawings, including:

FIG. 1 is a schematic representation of a device for elemental analysis of a sample to be studied, by optical emission spectrometry on laser-produced plasma, according to the invention;

FIG. 2 is a schematic representation, of an orthogonal projection on a base plane, of the relative positioning of a projection needle of a gas jet, and of an optical fiber of the device, relative to the plasma intended to be generated by the device;

FIG. 3 is a schematic representation of an inclination plane illustrating the inclination of the needle relative to the base plane;

FIG. 4 is a schematic representation illustrating a modification of the position of the sample during an analysis, to move a focus area.

### DETAILED DESCRIPTION

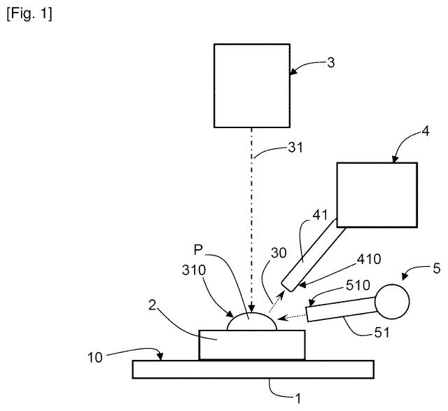

With reference to FIG. 1, a device for elemental analysis of a sample 2 to be studied, according to the invention, is shown.

This device comprises a base 1 which is intended to support a sample 2 to be studied.

This base 1 has in particular an upper surface 10 on which the sample 2 rests.

The sample 2 is more specifically integrated in a sample holder allowing the sample 2 to be studied to have a flat face to be studied extending parallel to the upper surface 10 of the base 1.

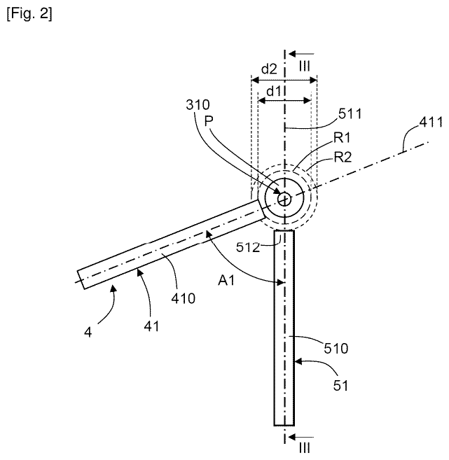

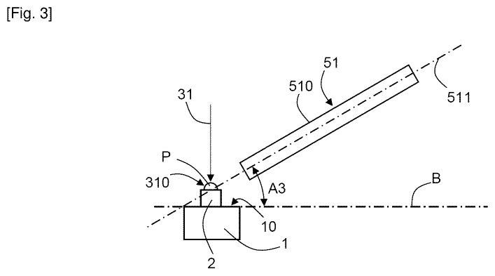

As a preliminary observation, FIG. 2 schematizes an orthogonal projection of components of the device described in more detail hereinafter, and more specifically of the orientation of these components, onto a plane, so-called the base plane B, in which the base 1 is inscribed. More precisely and with reference to FIG. 3, the upper surface 10 of the base 1 is inscribed in the base plane B.

The device also comprises a system 3 for generating a laser beam 31 which is intended to impact the sample 2 to generate a plasma P generating an optical emission 30.

This generating system 3 comprises a module for generating the laser beam 31, as well as, inter alia, a module for focusing the laser beam 31.

The generating system 3 is configured to focus the laser beam 31 in a focusing zone 310.

More specifically, the generating system 3 is configured to emit the laser beam orthogonally to the upper surface 10 of the base 1. Thus, the laser beam 31 is emitted orthogonally to the flat face to be studied of the sample 2.

The focusing zone 310 corresponds essentially to the point of origin of generation of the plasma P.

As mentioned previously, the laser beam 31 generates a plasma P which generates an optical emission 30. This optical emission 30 corresponds to light radiation.

The device also comprises, as illustrated in FIG. 1, collection means 4 of the optical emission 30.

With reference to FIGS. 1 to 3, the collection means 4 comprise an optical fiber 41, with a free end 410 that extends along a first optical axis 411 oriented towards the focusing zone 310.

The optical emission 30 is thus collected via the free end 410, which is as close as possible to the plasma P.

The closer the free end 410 of the optical fiber 41 is to the plasma P, and the better the collection of the optical emission 30, to the benefit of the quality of the analysis.

However, the closer the free end 410 of the optical fiber 41 is to the plasma P, the greater the risk of fouling of this free end 410 due to the dust generated by the plasma P.

With reference to FIGS. 1 to 3, the device comprises means 5 for projecting a gas jet onto the sample 2 to be studied.

These projection means 5 comprise a needle 51 projecting the gas jet.

This projection needle 51 has an end portion 510 that extends along a projection axis 511 that is oriented towards the focusing zone 310.

This projection needle 51 makes it possible to project the gas jet onto the plasma P, to improve the quality of the analysis as mentioned previously.

This gas jet thus produces a sheathing of the plasma P.

The gas jet also has the particularity of limiting fouling of a focusing lens of the generating system 3, but also limiting fouling of the free end 410 of the optical fiber 41.

Indeed, and as shown in FIG. 2, according to the orthogonal projection on the base plane B, the portion of the projection axis 511 located on the side of the projection needle 51 with respect to the focusing zone 310 forms an angle A1 less than or equal to 90° with the portion of the first optical axis 411 located on the side of the optical fiber 41 with respect to the focusing zone 310.

More specifically, the angle A1 is between 30° and 90°.

More precisely, the angle A1 is 45°.

With reference now to FIG. 3, a plane, called the inclination plane, is shown. This inclination plane illustrates the inclination of the projection needle 51 with respect to the bottom plane B. This inclination plane is also represented in FIG. 2 by the cutting lines III-III coincident on the projection axis 511.

So, the projection axis 511 is inscribed in this inclination plane, and this inclination plane extends orthogonally to the base plane B.

According to this inclination plane, the projection axis 511 forms an acute angle A3 less than or equal to 30° with respect to the base plane B.

With reference to FIG. 2, the projection needle 51 is substantially retracted with respect to the free end 410 of the optical fiber 41.

Indeed, according to the orthogonal projection on the base plane B, an opening end 512 of the projection needle 51 is positioned at a distance from the focusing zone 310 which is larger than that of the end 410 of the optical fiber 41 with respect to the focusing zone 310.

These distances are represented in FIG. 2 through the circles R1 and R2 centered on the focusing zone 310. The free end 410 of the optical fiber 41 is positioned on the circle R1 which has a diameter d1, and an opening end 512 of the projection needle 51 is positioned on the circle R2 which has a diameter d2.

According to this principle, the diameter d2 of the circle R2 is strictly greater than the diameter d1 of the circle R1.

To improve the quality of the projection of the gas jet while minimizing the gas consumption, then the projection means 5 of a gas jet are configured to project the gas jet at a flow rate of less than 1 L·min⁻¹, and the projection needle 51 has at its end portion 510 an inside diameter of less than 1 mm.

More specifically, the projection means 5 are configured to project the gas jet at a flow rate of 0.5 L·min⁻¹, and the projection needle 51 has at its end portion 510 an inner diameter equal to 0.5 mm.

In this way, the gas jet is projected at a particularly high speed and at a low flow rate, which minimizes gas consumption while optimizing the effects produced by the gas on the plasma P compared with what the prior art proposes.

This is because the fiber optic cable is better sheathed and protected against fouling.

In this way, it is also possible to improve the resolution and quality of the analysis because the optical fiber can be brought even closer to the plasma P.

The device described above makes it possible to implement a method for elementary analysis of a sample to be studied which simultaneously comprises a step of projecting a sample gas jet to be studied and a step of focusing a laser beam 30 in a focusing zone 310 on said sample 2 to be studied.

The focusing step makes it possible to produce a plasma P on the surface of this sample 2, and the gas jet is projected along the projection axis 511 oriented towards the focusing zone 310, this projection axis 511 corresponding to the orientation of the projection needle 51.

The method also comprises a step of analyzing the spectrum of the optical emission, corresponding to a light radiation, emitted by the plasma P. This analysis step is carried out by means of capturing this optical emission by the optical fiber 411 with the free end 410 extending along the first optical axis 411 oriented towards the focusing zone 310.

Finally, the analysis method comprises a step of determining from this analysis the spectrum of the elemental composition of the sample.

The method, during the step of projecting a gas jet, presents the parameters of the aforementioned device, in particular with respect to the angles adopted by the projection axis 511 with respect to the first optical axis 411 and the base plane B.

In addition, during the step of projecting a gas jet, the gas jet is projected at a flow rate lower than 1 L·min⁻¹, preferably with a flow rate of 0.5 L·min⁻¹, and at a speed higher than 21 meters per second, preferably equal to 42 meters per second.

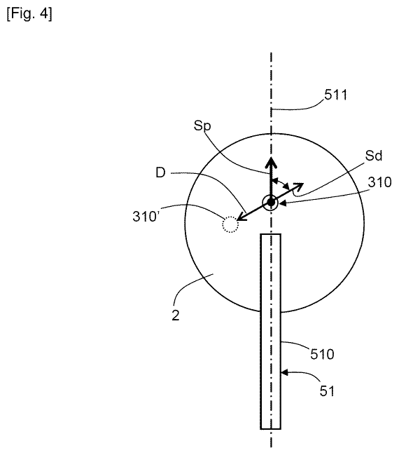

As illustrated by FIG. 4, the method also comprises a step of modifying the position of the sample 2 to be studied.

This modification step is conducted so as to move the focusing zone 310 on the surface of the sample 2.

The modification of the position of the sample 2 to be studied is carried out according to a movement vector Sd forming an angle less than or equal to 90° with respect to a projection vector Sp of the gas jet along the projection axis 511, according to an orthogonal projection on a plane in which the surface of the sample is inscribed.

As shown, a movement of the sample 2 according to the movement vector Sd makes it possible to modify the location of the focusing zone 310 to bring it to a new position 310′, according to the movement D.

In other words, the sample 2 is moved laterally or forward according to the projection vector Sp of the gas jet during the analysis, so as to retract the focusing zone 310 on a portion of the sample that is not covered with plasma dust ejected by the gas jet.

This step is also implemented by the device described previously which comprises means for moving the sample configured to implement this modification step.

Although the present disclosure has been described with reference to one or more examples, workers skilled in the art will recognize that changes may be made in form and detail without departing from the scope of the disclosure and/or the appended claims.

1. A device for elemental analysis of a sample to be studied, the device comprising:
a base to support a sample to be studied;
a system configured to generate a laser beam impact the sample to generate a plasma generating an optical emission, the system being configured to focus the laser beam in a focusing zone;
an optical collector for collecting the optical emission, comprising an optical fiber with a free end extending along a first optical axis oriented toward the focusing zone, to collect the optical emission;
a gas projector for projecting a gas jet onto the sample to be studied, comprising a needle to project the gas jet and having an end portion extending along a projection axis oriented toward the focusing zone;
wherein, according to an orthogonal projection on a base plane in which the base is inscribed, the portion of the projection axis located on the side of the projection needle with respect to the focusing zone forms an angle less than or equal to 90° with the portion of the first optical axis located on the side of the optical fiber with respect to the focusing zone,
and wherein the sample is movable relative to the focusing zone so as to move the focusing zone on the surface of the sample, according to a movement vector forming an angle less than or equal to 90° with respect to a projection vector of the gas jet along the projection axis, according to an orthogonal projection on a plane in which the surface of the sample is inscribed.

2. The device according to claim 1, wherein, according to an orthogonal projection on the base plane in which the base is inscribed, the part of the projection axis located on the side of the projection needle with respect to the focusing zone forms an angle between 30° and 90° with the part of the first optical axis located on the side of the optical fiber with respect to the focusing zone.

3. The device according to claim 2, wherein, according to an orthogonal projection onto the base plane in which the base is inscribed, the portion of the projection axis located on the side of the projection needle with respect to the focusing zone forms an angle of 45° with the portion of the first optical axis located on the side of the optical fiber with respect to the focusing zone.

8. The device according to claim 1, wherein, on a plane, so-called an inclination plane, in which the projection axis is inscribed, and where the inclination plane is orthogonal to the base plane, the projection axis forms an acute angle less than or equal to 30° with respect to the base plane.

5. The device according to claim 1, wherein, according to an orthogonal projection on the base plane, an opening end of the projection needle is positioned at a distance from the focusing zone that is greater than that of the free end of the optical fiber relative to the focusing zone.

6. The device according to claim 1, wherein the gas projector is configured to project the gas jet at a flow rate lower than 1 L·min⁻¹, and wherein the projection needle has at the end portion an inner diameter of less than 1 mm.

7. A method for elemental analysis of a sample to be studied, comprising:
simultaneously projecting a gas jet onto the sample to be studied, and of focusing a laser beam, in a focusing zone, onto said sample to be studied so as to produce a plasma on the surface of the sample, the gas jet being projected along a projection axis oriented towards the focusing zone;
analyzing a spectrum of the optical emission emitted by the plasma using an optical fiber with a free end extending along a first optical axis oriented towards the focusing zone, the optical emission being collected via the free end;
determining, from the analysis of the spectrum, an elemental composition of the sample;
during the projecting of the gas jet, and according to an orthogonal projection onto a plane in which the surface of the sample is inscribed, the portion of the projection axis located on the side of the projection needle with respect to the focusing zone forms an angle less than or equal to 90° with the portion of the first optical axis located on the side of the optical fiber with respect to the focusing zone,
modifying a position of the sample to be studied according to a movement vector forming an angle less than or equal to 90° with respect to a projection vector of the gas jet along the projection axis, according to an orthogonal projection onto a plane in which the surface of the sample is inscribed.

8. The method according to the claim 7, wherein, during the projecting of the gas jet, the gas jet is projected at a flow rate lower than 1 L·min⁻¹, and at a speed higher than 21 m·s⁻¹.

9. The method according to claim 7, wherein movement vector forms an angle of 0° with respect to the projection vector of the gas jet along the projection axis, according to the orthogonal projection onto the plane in which the surface of the sample is inscribed.
